(19) United States
(12) Patent Application Publication
(10) Pub. No.: US 2003/0176954 A1
(43) Pub. Date: Sep. 18, 2003

(54) Tracking and control of gas turbine engine component damage/life

(76) Inventor: Link C. Jaw, Scottsdale, AZ (US)

Correspondence Address: The Halvorson Law Firm, 405 W. Southern Ave., Ste. 1, Tempe, AZ, 85282, US

(21) Appl. No.: 10/265,530

(22) Filed: Oct. 4, 2002

Related U.S. Application Data
(60) Provisional application No. 60/328,457, filed on Oct. 12, 2001.

(51) Int. Cl. G05D 1/00

(52) U.S. Cl. 701/3; 701/8

(57) ABSTRACT

Described herein are damage control mechanisms and methods to extend the on-wing life of critical gas turbine engine components. Particularly, two types of damage mechanisms are addressed: creep/rupture and thermo-mechanical fatigue. To control these damages and extend the life of engine hot-section components, two methodologies are implemented as additional control logic for the on-board electronic control unit. This new logic, the life-extending control (LEC), interacts with the engine control and monitoring unit and modifies the fuel flow to reduce component damages in a flight mission. The LEC methodologies were demonstrated in a real-time, hardware-in-the-loop simulation. The results show that LEC is not only a new paradigm or engine control design, but also a promising technology for extending the service life of engine components, hence reducing the life cycle cost of the engine.

This application is a continuation of provisional patent No. 60/328,457 filed on Oct. 12, 2001.

### FIELD OF THE INVENTION

The present invention relates to a method for controlling damage to engine components and extending the useful life of engine components.

### BACKGROUND

Gas turbine engines primarily consist of rotating components. These rotating components operate under cyclic loading conditions and harsh environments (i.e., under high temperatures, pressures, corrosion conditions) such that the deterioration of these components is accelerated. Deterioration is generally tracked by damage, or damage rates, for different damage mechanisms. The most common damage mechanisms for a gas turbine engine include, but are not limited to: low cycle fatigue (LCF), thermo-mechanical fatigue (TMF), high cycle fatigue (HCF), creep, rupture, corrosion, and foreign object-induced damages (FOD). Of these common damage mechanisms, LCF and HCF are primarily design issues; FOD and corrosion are ambient-condition driven; hence TMF, creep, and rupture are the prime candidates for damage control and life extension on a continuous-operation basis.

TMF, creep, and rupture have similar damage patterns. The simplest pattern is where the damage rate (d) is geometrically proportional to a key engine operating parameter (x), sometimes called a damage driver, as shown in FIG. 1. To fully analyze damage mechanisms more accurately, additional damage drivers are often considered. The additional damage drivers are revealed in more complex damage patterns as shown in FIGS. 2 and 3.

Generally speaking, the approaches to controlling the damage and extending component life fall into two categories:

Passive control, which is tracking damages and adjusting maintenance practices to maximize the utilization of the service life of a component.

Active control, which is changing the operating procedures pertaining to mission planning or engine control, and tracking the damage concurrently. By concurrent tracking of damages we mean the time from feeding damage information back to mission planning or engine control is much shorter compared to the passive control approach.

There is a current and continuing need for improved damage control and component life extension methods.

### SUMMARY OF INVENTION

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWING

FIG. 1: A simple damage pattern

FIG. 2: A complex damage patterns

FIG. 3: Another damage pattern

FIG. 4: A trade-off between performance and rupture/creep damage in cruise conditions

FIG. 5: A typical flight mission of the business jet

FIG. 6: Cumulative damage of un-cooled blade during cruise

FIG. 7: Cumulative damage of cooled blade during cruise

FIG. 8: Cumulative damage of un-cooled stator during cruise

FIG. 9: Fuel consumption during cruise

FIG. 10: Objective function value at different cruise Mach number

FIG. 11: Illustration of acceleration schedule reduction logic

FIG. 12: TMF reduction vs. reduction of acceleration schedule vs. speed threshold

FIG. 13: TMF reduction vs. increase in rise time vs. speed threshold

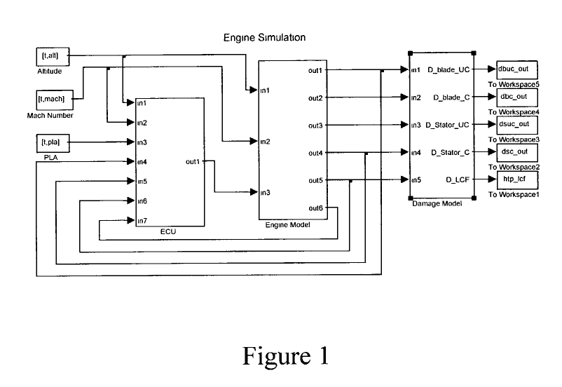

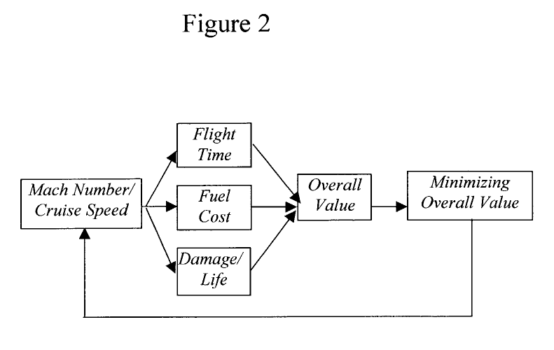

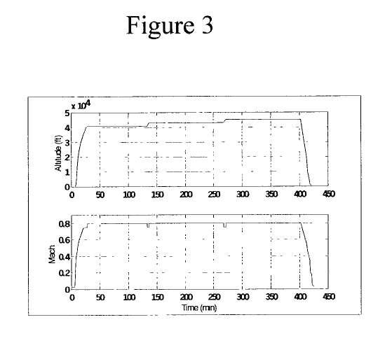

### DETAILED DESCRIPTION OF PREFERRED EMBODIMENTS

The present invention is useful for controlling engine damage and extending the useful life of engine components.

The present invention concerns the active control approach, specifically, extending the life of hot-section components through active engine control of TMF, creep, and rupture damages. This approach is called life-extending control (LEC). The LEC concept originates from damage mitigating control research for rocket engines where engine fuel flow rate is controlled by including damage-reduction as an active objective. However, applying this approach to non-rocket engines is not obvious. The differences between a liquid-fueled rocket engine and a gas turbine engine are: 1) rocket engines have a narrow operating envelope, their mission profile is mostly fixed; 2) rocket engines have much a shorter firing duration; 3) rocket engines have much longer down times for each mission cycle; and 4) rocket engines have no air breathing provision, hence, not susceptible to contamination and corrosion.

The challenge of LEC is to maintain satisfactory levels of performance and operability while reducing component damages. To meet this challenge, LEC is preferably designed to trim the standard engine control logic with a limited authority.

As an example, the present application describes two methodologies used to reduce the life cycle cost of gas turbine engines. These methodologies may be applied to other non-gasoline engines and still fall within the scope of the claims of the present application. The first methodology reduces stress rupture/creep damage to turbine blades and stators by optimizing damage accumulation concurrently with the flight mission. This methodology is described below. The second methodology modifies the baseline control logic of an engine to reduce the TMF damage of cooled stators during acceleration. This methodology is also described below. These methodologies have been implemented in an actual full-authority digital electronic control (FADEC) unit of a small gas turbine engine to demonstrate the utility of LEC. A real-time, hardware-in-the-loop (HITL) simulation has also been conducted as a part of the utility demonstration.

A typical flight mission of an aircraft consists of taxi, take-off, climb, cruise, descent and landing. In this section, the reduction of rupture damage during a specific portion of a flight mission/cruise is described. Since civil airplanes spend most of their flight time at the cruise condition, reducing engine component damages during cruise will directly increase the service life of the engine components.

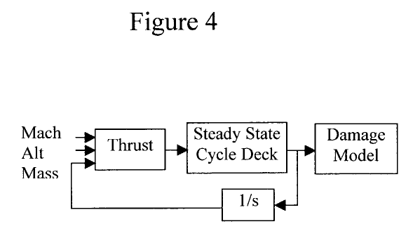

Generally speaking, increasing cruise speed reduces flight time but increases the thrust requirement. This implies higher engine speed and temperature, hence high damage rate to the turbine blades and stators. Therefore, there is trade-off among flight time, fuel cost, and accumulated component damages during the cruise condition. A formulation that performs this optimization trade-off among flight time, fuel cost, and accumulated engine component damages during cruise was formulated and is shown in FIG. 4.

Flight Mission

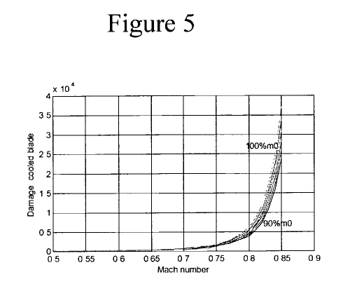

A business jet was used to demonstrate this trade-off optimization formulation. A typical flight mission of this type of aircraft is shown in FIG. 5. There are three cruise segments in the flight mission. The first cruise segment is at altitude 41,000 ft, the second cruise segment is at altitude 43,000 ft, and the third cruise segment is at altitude 45,000 ft. The Mach number for all three cruise segments is 0.8.

Aircraft Model

From the equations of motion of an aircraft in level flight, the required engine thrust in cruise condition can be determined from the following two equations:

$$\begin{matrix}T = \frac{1}{2} ρ {SC}_{d} {V}^{2} & ( 1 ) \\ mg = \frac{1}{2} ρ {SC}_{l} {V}^{2} & ( 2 )\end{matrix}$$

where ρ is the density of the air, S is the reference area of the aircraft, C_{d} is the drag coefficient, Cₗ is the lift coefficient, V is the cruise speed.

The relationship between C_{d} and Cₗ is described by the drag-polar equation:

C_{d}=C_{d0}+βCₗ²

where the zero-lift drag coefficient C_{d0} and the induce drag factor β are functions of Mach number only.

The thrust T, as a function of cruise speed and mass of aircraft, can be written as

$$T = \frac{1}{2} ρ {SC}_{d0} {V}^{2} + 2 β \frac{{m}^{2} {g}^{2}}{ρ {SV}^{2}} \qquad ( 4 )$$

Cumulative Damage In Cruise

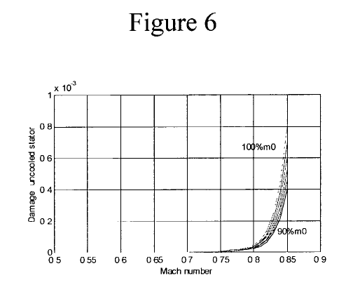

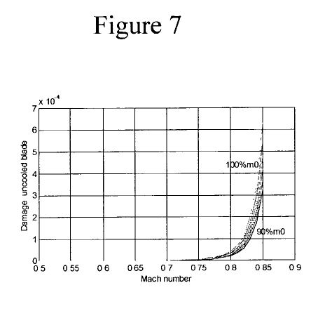

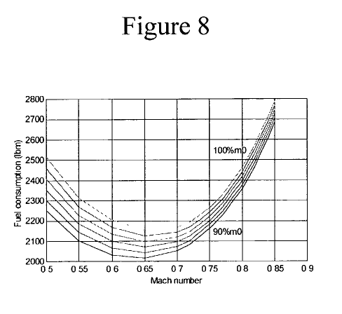

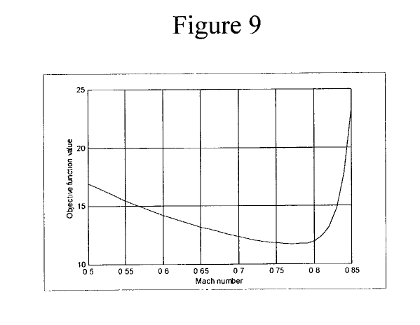

Based on the required thrust determined by Eq. (4), cumulative component damages during cruise are determined by using a damage model. For the first cruise segment of the mission profile (altitude 41,000 ft, cruise speed 0.8 Mach, cruise time 105 min), FIG. 6 to FIG. 8 show the cumulative damages for blades and stators. FIG. 9 shows the total fuel consumption as a function of cruise Mach number and initial weight with respect to a reference initial weight mₒg.

It can be seen from these figures that the cumulative component damage during cruise increases exponentially with respect to the Mach number. Large damage reduction can be achieved with very small sacrifice in flight time.

Trade-Off Optimization

To demonstrate this optimization approach, a linear objective function of flight time, fuel consumption and cumulative damage is formulated as follows:

$$J = {α}_{1} \frac{{t}_{f}}{{t}_{f\_ref}} + {α}_{2} \frac{{D}_{1}}{{D}_{1 \_ref}} + {α}_{3} \frac{{D}_{2}}{{D}_{2 \_ref}} + {α}_{4} \frac{{D}_{3}}{{D}_{3 \_ref}} + {α}_{5} \frac{WF}{{WF}_{ref}} \qquad ( 5 )$$

where

t_{f}: Cruise time

t_{f}_{_{—}}_{ref}: Cruise time at a nominal cruise Mach number

D₁: Cumulative damage for uncooled blade

D₁_{_{—}}_{ref}:Cumulative damage for uncooled blade at a nominal cruise Mach number

D₂: Cumulative damage for cooled blade

D₂_{_{—}}_{ref}:Cumulative damage for uncooled blade at a nominal cruise Mach number

D₃: Cumulative damage for cooled stator

D₃_{_{—}}_{ref}: Cumulative damage for uncooled stator at a nominal cruise Mach number

WF: Total fuel consumption during cruise

WF_{ref}: Total fuel consumption during cruise at a nominal cruise Mach number

α₁: Weighting coefficients

Assume α₁=10, α₂=α₃=α₄=⅓, α₅=1. For different reference cruise Mach numbers 0.70, 0.75, 0.80, Table 1 below lists the optimal Mach number, the damages at the optimal cruise Mach number divided by the damages at the reference cruise Mach number, and the fuel consumption at the optimal cruise Mach number divided by the fuel consumption at the reference cruise Mach number, for three reference Mach numbers.

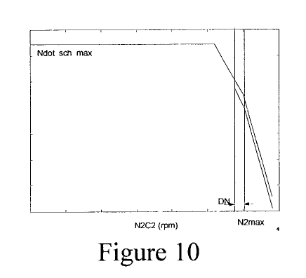

Note that the objective function reaches its minimum at the reference cruise Mach number below 0.70. This is caused by the large weighting on the cruise time in the objective function. The objective function at different Mach number for the reference Mach number 0.8 is shown in FIG. 10. For the Mach numbers greater than 0.75, more reduction in Cumulative damages can be achieved with small reduction in cruise speed.

Optimization results

| Ref. Mach | Optimal Mach | $\frac{{D}_{1}}{{D}_{1 \_ref}}$ | $\frac{{D}_{2}}{{D}_{2 \_ref}}$ | $\frac{{D}_{3}}{{D}_{3 \_ref}}$ | $\frac{D}{{D}_{ref}}$ |
|---|---|---|---|---|---|
| 0.70 | 0.70 | 1.0 | 1.0 | 1.0 | 1.0 |
| 0.75 | 0.72 | 0.43 | 0.58 | 0.41 | 0.96 |
| 0.80 | 0.77 | 0.32 | 0.48 | 0.30 | 0.94 |

### 3. TMF Damage Reduction

The actual engine control logic is modified to reduce the TMF damage during engine acceleration from ground idle to maximum power. The goal is to reduce the TMF damage while maintaining fast engine acceleration. Several approaches to modifying engine control logic have been investigated, including: target speed offset, control gain increase/decrease and acceleration schedule reduction. It was found from engine simulation that acceleration schedule reduction is the most effective single approach.

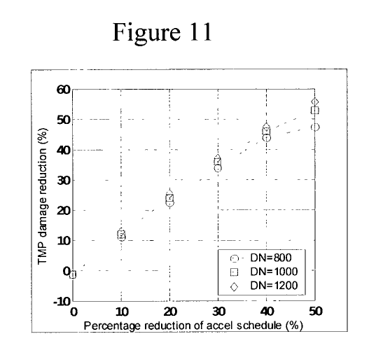

In a typical turbine engine control, engine acceleration, and therefore engine speed, follows an acceleration schedule. To reduce TMF damage, the acceleration schedule is reduced by a certain percentage once the difference between the controlled speed, high pressure spool speed (NH) and the target speed is less than a threshold. This is illustrated in FIG. 11 below.

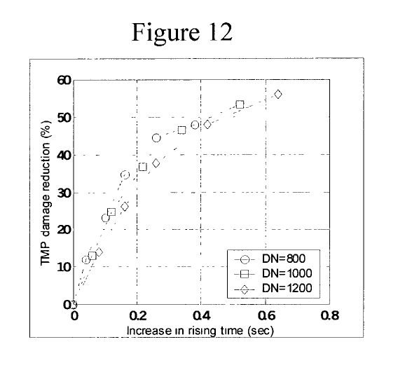

For the threshold values (DN) of 800 rpm, 1000 rpm, and 1200 rpm, the reductions in TMF damage (in percentage) and the increase of rise time of fan speed (N1) (an indicator of engine thrust) during the engine acceleration from ground idle to maximum power are shown in Tables 2 to Table 4, and in FIG. 12 and FIG. 13 for 50% to 90% reduction of the acceleration schedule. It can be seen that the greater the reduction of TMF damage, the greater the increase in rise time. It is also found that the relationship between the TMF damage reduction and increase in rise time is not sensitive to the threshold values. For all three cases, significant reductions in TMF damage can be achieved with only a very small increase in rise time for N1 and thrust.

TABLE 2
TMF damage reduction for DN = 800 rpm

| % Acceleration | TMF Reduction | Extra Rise Time |
|---|---|---|
| Schedule Reduction | (%) | (sec) |
| 10% | 13.7 | 0.06 |
| 20% | 24.5 | 0.12 |
| 30% | 35.3 | 0.22 |
| 40% | 45.6 | 0.32 |
| 50% | 49.0 | 0.58 |

TABLE 4
TMF damage reduction for DN = 1000 rpm

| % Acceleration | TMF Reduction | Extra Rise Time |
|---|---|---|
| Schedule Reduction | (%) | (sec) |
| 10% | 14.7 | 0.06 |
| 20% | 26.4 | 0.16 |
| 30% | 37.7 | 0.28 |
| 40% | 47.5 | 0.40 |
| 50% | 54.3 | 0.74 |

TABLE 5
TMF damage reduction for DN = 1200 rpm

| % Acceleration | TMF Reduction | Extra Rise Time |
|---|---|---|
| Schedule Reduction | (%) | (sec) |
| 10% | 14.7 | 0.08 |
| 20% | 27.5 | 0.18 |
| 30% | 39.2 | 0.32 |
| 40% | 49.0 | 0.50 |
| 50% | 56.9 | 0.86 |

The methodologies have been implemented in an actual full-authority digital electronic control (FADEC) unit of a small gas turbine engine to demonstrate the usefulness of LEC. Real-time, hardware-in-the-loop simulations have been conducted, verifying the LEC concept through the two life extension methodologies. FIG. 14 shows the simulation environment and a data screen.

This application describes two methodologies to extend the service life of hot-section components, particularly, turbine blades and stators, by reducing the damages incurred on these components. One methodology has been designed to reduce the creep damage in cruise. The other methodology has been designed to reduce the thermo-mechanical fatigue damage in rapid transients. These methodologies for damage reduction and life extension have been evaluated for a small commercial turbine engine for a general aviation aircraft. Evaluation was performed by hardware-in-the-loop simulations, where an actual engine full-authority digital electronic control (FADEC) unit was modified with the LEC, which then interacted with an engine simulator in real time. The results of this evaluation show that significant reductions in these damages are possible and the design for life extension should be considered in engine control systems.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A method for controlling engine damage an extending the useful life of engine components of an aircraft comprising the steps of:
a. determine cumulative component damage using a predetermined damage model,
b. minimizing the cumulative component damage and minimizing flight time by varying the Mach number of the aircraft.
